(19) United States
(12) Patent Application Publication
(10) Pub. No.: US 2026/0100866 A1
(43) Pub. Date: Apr. 9, 2026

(54) COMMUNICATION SYSTEM

(71) Applicant: SICK OPTEX CO., LTD., Kyoto (JP)

(72) Inventors: Tasuku YUGUCHI, Kyoto (JP); Naoki INOUE, Kyoto (JP)

(21) Appl. No.: 19/330,786

(22) Filed: Sep. 16, 2025

(30) Foreign Application Priority Data
Oct. 9, 2024 (JP) 2024-177344

(51) Int. Cl. H04L 25/02

(52) U.S. Cl. CPC H04L 25/0286; H04L 25/0278

(57) ABSTRACT

The communication system includes a push-pull transmitter circuit (2) that includes a reflection signal attenuator circuit (10) configured to keep the reflection signals outside of the amplitude direction of communication signals to prevent contamination thereof. The reflection signal attenuator circuit (10) includes first and second rectifier elements (D1 and D2) connected in series to a high-side drive element and a low-side drive element (Q1 and Q2), respectively, to prevent the reflection signals from the communication signals from flowing back to a power supply side, and first and second voltage cap elements (ZD1 and ZD2) connected in parallel to the high-side drive element and the low-side drive element (Q1 and Q2), respectively, to provide (add or subtract) capping voltages equal to approximately 1.5 to 3 times upper or lower boundaries for a HIGH level voltage of the communication signals when passing the reflection signals from the communication signals therethrough.

### CROSS REFERENCE TO THE RELATED APPLICATION

This application is based on and claims Convention priority to a Japanese patent application No. 2024-177344 filed Oct. 9, 2024, the entire disclosure of which is herein incorporated by reference as a part of this application.

### BACKGROUND OF THE INVENTION

### Field of the Invention

The present invention relates to a communication system which attenuates reflection signals that may appear on a transmission line over which communication signals are transmitted.

### Description of Related Art

In communication systems that use an electrical line to transmit communication signals, it is typically required for the transmitter side, the receiver side, and the electrical line to have matching impedance. In case of a transmission line with mismatched impedance, there is a risk that reflection signals arising from the mismatch may contaminate communication signals. FIG. 7 depicts a transmitted waveform, a received waveform containing reflection waveforms, and a binarized result of the received waveform.

An example situation is considered in which the impedance Zt of each of the transmitter side and the electrical line is 50Ω and the impedance Zr of the receiver side is 1000Ω. Supposing that the symbol At represents the signal amplitude on the transmitter side, the reflection coefficient (or reflection amplitude) Γₙ is given by equation (1):

$${Γ}_{n} = At \times {\{ ( Zr - Zt ) \div ( Zr + Zt ) \}}^{n} \qquad ( 1 )$$

The initial reflection amplitude (where n=1) would then be:

$${Γ}_{1} = At \times {\{ ( 1 \; 000 - 50 ) \div ( 1000 + 50 ) \}}^{1} = 0.9 At$$

Thus, a reflection waveform with 0.90 times the signal amplitude At on the transmitter side would appear.

A reflection time t, which is proportional to a line length L, is given by:

$$t ( s ) = 2 L \div υ \qquad ( 2 )$$

where ν denotes the transmission velocity of signals on the electrical line. For an electrical line that uses a typical coaxial cable or twisted pair cable (where ν is equal to about 2×10⁸ m/s), with an example length L of 100 m, the reflection time t would be:

$$t = 2 \times 100 \div ( 2 \times 1 {0}^{8} ) = 1 \times 1 {0}^{- 6} = 1 ( μs )$$

When the reflection amplitude Γ₁ is really high, and a received waveform may dip below a binarization voltage threshold Vt like in FIG. 7, this situation is analogous to signals demodulated on the receiver side being contaminated with noise, thus, having an effect on the quality of the communication.

FIGS. 8 and 9 depict conventional push-pull transmitter circuits that include a communication signal drive transistor Q11 serving as a high-side drive element and a communication signal drive transistor Q12 serving as a low-side drive element. A high-side drive signal turns on the Q11 to drive communication signals at HIGH level, while a low-side drive signal turns on the Q12 to drive the communication signals at LOW level. Both the Q11 and the Q12 are switched off when it is wished to create a non-activated state having a high impedance.

A rectifier element (or diode) D11 is connected in parallel to the transistor Q11 to protect the transistor Q12 from voltages exceeding the withstand voltage of the transistor Q12 when electrical current of a reflection signal flows in via a positive communication signal side, by letting the current of the reflection signal pass therethrough to the positive supply side. In so doing, the maximum voltage on the positive communication signal side is capped at the voltage of the positive supply plus the forward voltage of the diode D11. A diode D12 is connected in parallel to the transistor Q12 to prevent the transistor Q11 from exceeding its own withstand voltage when electrical current of a reflection signal flows out via the positive communication signal side, by letting the current of the reflection signal pass therethrough to the negative communication signal side. In so doing, the minimum voltage on the positive communication signal side is capped at the voltage of the negative supply minus the forward voltage of the diode D12.

A capacitor C11 is a bypass capacitor used to provide reduced high-frequency impedance between the positive supply side and the negative supply side and between the positive supply side and the negative communication signal side. And it acts to pass electrical current of a reflection signal flowing in via the positive communication signal side during high-side driving periods, from the positive communication signal side to the negative communication signal side through the positive supply side, the capacitor C11, and the negative supply side.

The point (20) in FIG. 7 indicates a reflection waveform at the start of a high-side driving period. At this point, electrical current of the reflection signal flows through the transmitter circuit of FIG. 8 along the route (A). That is, the current passes from the negative communication signal side to the positive communication signal side through the capacitor C11 and the transistor Q11. As the reflection time t elapses, the reflection signal flips as shown at the point (21) on the receiver side, so that the current of the reflection signal flows through the transmitter circuit of FIG. 8 along the route (B). That is, the current passes from the positive communication signal side to the negative communication signal side through the diode D11 and the capacitor C11. Thus, the reflection signal oscillates with an amplitude Γ₁ about the voltage of the positive supply.

The point (22) in FIG. 7 indicates a reflection signal at the start of a low-side driving period. At this point, electrical current of the reflection signal flows through the transmitter circuit of FIG. 9 along the route (B). As the reflection time t elapses, the reflection signal flips as shown at the point (23) on the receiver side, so that the current of the reflection signal flows through the transmitter circuit of FIG. 9 along the route (A). Thus, the reflection signal oscillates with an amplitude Γ₁ about the voltage of the negative supply.

Accordingly, the reflection waveform could dip below the binarization voltage threshold Vt at the point (21) and rise above the binarization voltage threshold Vt at the point (23) in FIG. 7 such that the reflection signal crosses the binarization voltage threshold Vt at the points (21) and (23), thereby generating discontinuities in a binarized result of the received waveform. This noise contamination may create binarized results with values deviating from the original communication signals.

Various countermeasures against such contamination by reflection signals are known from the past. For instance, it is known to conduct binarization in anticipation of the presence of a reflection waveform at the time of demodulating received signals (e.g., WO2008/038388A1) or to make adjustments to transmitter impedance for the purpose of attenuating a reflection waveform (e.g., JP2009-296568A).

Among others, it is also known to provide a receiver circuit that has a feature to correct (or shape) a reflection waveform for correct demodulation in the presence of reflection waveforms (e.g., JP2011-239091A) or to select an electrical line with a prescribed length that will alleviate a reflection waveform (or ringing) appearing on branch lines (e.g., JP2016-051968A). These prior technologies intend to achieve improved communication quality by utilizing a transmission line in a way that attenuates a reflection waveform generated from mismatched impedance or by correcting a reflection waveform on the side of a receiver.

### SUMMARY OF THE INVENTION

However, these past countermeasures against reflection waves involve a complex circuit configuration or require circuit changes each time a different electrical line length is used, thereby possibly complicating circuit designs.

An object of the present invention is to overcome the abovementioned issues by providing a communication system with a simple circuit configuration that is capable of easily attenuating reflection waves with no need for circuit changes when a different electrical line length is used.

In order to achieve such an object, the present invention provides a communication system that includes a push-pull transmitter circuit and a receiver circuit. The push-pull transmitter circuit includes a high-side drive element and a low-side drive element to transmit communication signals having HIGH and LOW level binary values. The push-pull transmitter circuit also includes a reflection signal attenuator circuit configured to attenuate an effect that reflection signals appearing on a transmission line of the communication system has on the communication signals by biasing the reflection signals outwards of an amplitude direction of the communication signals to prevent contamination thereof. The receiver circuit is configured to receive and discriminate HIGH and LOW levels of the communication signals with a binarization voltage threshold.

The reflection signal attenuator circuit includes: first and second rectifier elements connected in series to the high-side drive element and the low-side drive element, respectively, and configured to prevent the reflection signals from flowing back to a power supply side from the communication signals; and first and second voltage cap elements connected in parallel to the high-side drive element and the low-side drive element, respectively, and configured to add or subtract capping voltages, equal to approximately 1.5 to 3 times upper or lower boundaries (e.g., voltages) for a HIGH level voltage of the communication signals, to or from the boundaries when passing the reflection signals from the communication signals therethrough.

The capping voltages added or subtracted by the first and second voltage cap elements are chosen to be equal to approximately 1.5 to 3 times the boundaries in order to ensure that the communication signals are not contaminated with the reflection signals or in consideration of the withstand voltages of the drive elements.

According to this configuration, the reflection signal attenuator circuit of the push-pull transmitter circuit includes first and second rectifier elements connected in series to the high-side drive element and the low-side drive element, respectively, as well as first and second voltage cap elements connected in parallel to the high-side drive element and the low-side drive element, respectively, to add or subtract capping voltages equal to approximately 1.5 to 3 times upper or lower boundaries for a HIGH level voltage. This will bias the reflection signals outwards of the amplitude direction of the communication signals to prevent the amplitude of the communication signals from being jeopardized by the reflection signals, thereby keeping the reflection signals from crossing the binarization voltage threshold and from contaminating the communication signals. In this way, attenuation of reflection signals can be easily achieved with a simple circuit configuration with no need for circuit changes when a different electrical line length is used, thereby facilitating long-distance transmission as well as bus branching easily.

Also, the reflection signal attenuator circuit may be configured such that: the first rectifier element connected in series to the high-side drive element prevents positive electrical current of the reflection signals from flowing back to a positive supply side from the communication signals; the second voltage cap element connected in parallel to the low-side drive element adds a capping voltage equal to approximately 1.5 to 3 times a positive upper boundary for the HIGH level voltage when passing the positive electrical current from the communication signals therethrough; the second rectifier element connected in series to an output of the low-side drive element prevents negative electrical current of the reflection signals from flowing back to a negative supply side from the communication signals; and the first voltage cap element connected in parallel to the high-side drive element subtracts a capping voltage equal to approximately 1.5 to 3 times a negative lower boundary for the HIGH level voltage when passing the negative electrical current of the reflection signals from the communication signals therethrough.

In this way, attenuation of reflection signals can be easily achieved with a simple circuit configuration with no need for circuit changes when a different electrical line length is used.

Preferably, the first and second voltage cap elements are configured to add or subtract capping voltages equal to approximately twice the upper or lower boundaries for the HIGH level voltage. Hence, attenuation of reflection signals can be easily achieved with a much simpler circuit configuration.

It should be noted that the preceding configurations for the communication system can be better clarified in some parts to give the following configurations (A) to (C). Accordingly, needless to say, the following configurations do not have a scope of protection or technical scope that significantly deviates from those of the preceding configurations:

(A) A communication system that includes:

a push-pull transmitter circuit including a high-side drive element and a low-side drive element to transmit communication signals having HIGH and LOW level binary values, with the transmitter circuit also including a reflection signal attenuator circuit or a reflection signal rectifier circuit configured to attenuate an effect that reflection signals appearing on a transmission line of the communication system has on the communication signals by biasing the reflection signals outwards of an amplitude direction of the communication signals to prevent contamination thereof;

and

a receiver circuit configured to receive and discriminate HIGH and LOW levels of the communication signals with a binarization voltage threshold,

the reflection signal attenuator circuit including:
first and second rectifier elements connected in series to the high-side drive element and the low-side drive element, respectively, and configured to prevent the reflection signals from flowing back to a power supply side from the communication signals; and
first and second voltage cap elements connected in parallel to the high-side drive element and the low-side drive element, respectively, and configured to keep upper or lower boundaries of a waveform of the reflection signals on the communication signals within capping voltages equal to approximately 1.5 to 3 times a transmission amplitude At of the communication signals when passing the reflection signals from the communication signals therethrough;

(B) A communication system according to the preceding configuration (A), in which the reflection signal attenuator circuit is configured such that:

the first rectifier element connected in series to the high-side drive element prevents positive electrical current of the reflection signals from flowing back to a positive supply side from the communication signals;

the second voltage cap element connected in parallel to the low-side drive element keeps a positive upper boundary of the waveform of the reflection signals within a capping voltage equal to approximately 1.5 to 3 times the transmission amplitude At when passing the positive electrical current from the communication signals therethrough;

the second rectifier element connected in series to an output of the low-side drive element prevents negative electrical current of the reflection signals from flowing back to a negative supply side from the communication signals; and

the first voltage cap element connected in parallel to the high-side drive element keeps a negative lower boundary of the waveform of the reflection signals within a capping voltage equal to approximately 1.5 to 3 times the transmission amplitude At when passing the negative electrical current of the reflection signals from the communication signals therethrough; and

(C) A communication system according to one of the preceding configurations (A) or (B), in which the first and second voltage cap elements are configured to keep within the capping voltages equal to approximately twice the transmission amplitude At.

Any combinations of at least two features disclosed in the claims and/or the specification and/or the drawings should also be construed as encompassed by the present invention. Especially, any combinations of two or more of the claims should also be construed as encompassed by the present disclosure.

### BRIEF DESCRIPTION OF THE DRAWINGS

The present invention will be more clearly understood from the following description of preferred embodiments made with reference to the accompanying drawings. However, the embodiments and the drawings are given merely for the purpose of illustration and explanation, and should not be used to delimit the scope of the present invention, which scope is to be delimited by the appended claims. In the accompanying drawings, alike numerals are assigned to and indicate alike parts throughout the different figures.

FIG. 1 is a circuit diagram of a transmitter circuit of a communication system in accordance with an embodiment of the present invention;

FIG. 2 is a circuit diagram of a receiver circuit of the communication system;

FIG. 3 illustrates how reflection signals flow during high-side driving periods of the transmitter circuit;

FIG. 4 illustrates how reflection signals flow during low-side driving periods of the transmitter circuit;

FIG. 5 illustrates a waveform on the receiver side;

FIG. 6 illustrates a waveform on the transmitter side;

FIG. 7 illustrates a transmitted waveform, a received waveform containing reflection waveforms, and a binarized result of the received waveform in accordance with a conventional example;

FIG. 8 illustrates how reflection signals flow during high-side driving periods of a conventional transmitter circuit; and

FIG. 9 illustrates how reflection signals flow during low-side driving periods of the conventional transmitter circuit.

### DESCRIPTION OF EMBODIMENTS

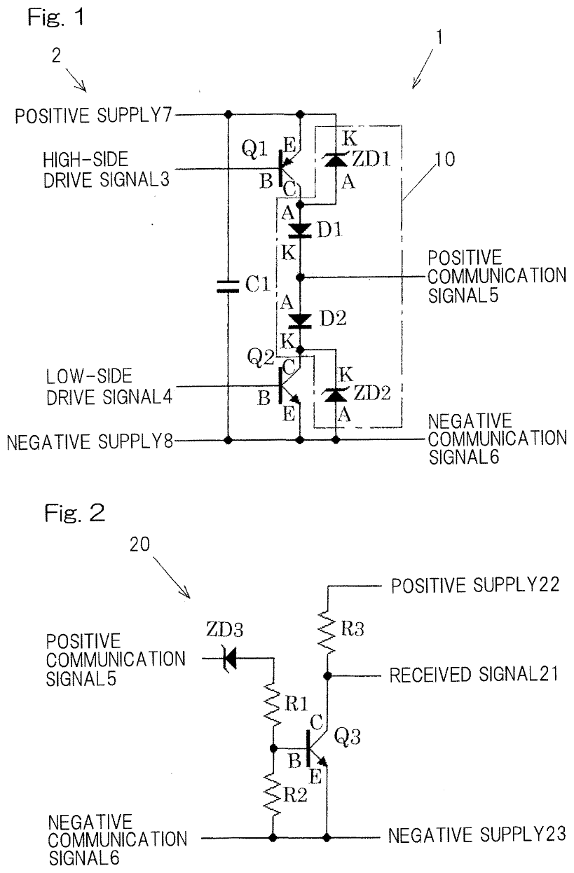

What follows is a description of preferred embodiments of the present invention, made with reference to the drawings. FIG. 1 depicts a transmitter circuit 2 of a communication system 1 in accordance with an embodiment of the present invention. The transmitter circuit 2 is in the form of a push-pull output circuit that includes a high-side drive element (e.g., a communication signal drive PNP transistor Q1) and a low-side drive element (e.g., a communication signal drive NPN transistor Q2) to transmit communication signals having HIGH and LOW level binary values.

To drive a communication signal at HIGH level, a high-side drive signal 3 is applied to a base B of the transistor Q1 to turn on the transistor Q1. To drive a communication signal at LOW level, a low-side drive signal 4 is applied to a base B of the transistor Q2 to turn on the transistor Q2. Both the transistor Q1 and the transistor Q2 are switched off when it is wished to create a non-activated state having a high impedance.

The transmitter circuit 2 includes a reflection wave attenuator circuit 10 configured to attenuate an effect that reflection waves appearing on a transmission line of the communication system 1 has on the communication signals. The reflection wave attenuator circuit 10 includes first and second voltage cap elements (e.g., Zener diodes ZD1 and ZD2) and first and second rectifier elements (e.g., rectifier diodes D1 and D2).

A positive supply 7 is connected to the junction between an emitter E of the transistor Q1 and a cathode K of the Zener diode ZD1. A negative supply 8 is connected to the junction between an emitter E of the transistor Q2 and an anode A of the Zener diode ZD2. A positive communication signal 5 is output via the junction between a cathode K of the rectifier diode D1 and an anode A of the rectifier diode D2. A negative communication signal 6 is output via the junction between the emitter E of the transistor Q2 and the anode A of the Zener diode ZD2.

The high-side drive rectifier diode D1 is connected in series to the junction between a collector C of the transistor Q1 and an anode A of the Zener diode ZD1 to prevent positive electrical current of the reflection signals flowing in via the positive communication signal 5 side from flowing back to the positive power supply 7 side. The low-side drive rectifier diode D2 is connected in series to the junction between a collector C of the transistor Q2 and a cathode K of the Zener diode ZD2 to prevent negative electrical current of the reflection signals flowing in via the positive communication signal 5 side from flowing back to the negative power supply 8 side.

The Zener diode ZD1 is connected in parallel to the transistor Q1 for voltage subtraction when negative electrical current of reflection signals flows in via the positive communication signal 5 side, such that the voltage of the positive supply 7 minus the voltage across the Zener diode ZD1 is applied to the positive communication signal 5. The Zener diode ZD2 is connected in parallel to the transistor Q2 for voltage addition when positive electrical current of reflection signals flows out via the positive communication signal 5 side, such that the voltage of the negative supply 8 plus the voltage across the Zener diode ZD2 is applied to the positive communication signal 5.

Here, the Zener diodes ZD1 and ZD2 are configured to provide capping voltages or to add or subtract a breakdown voltage to or from the upper or lower boundary for a HIGH level voltage of the communication signals, the breakdown voltage to be a capping voltage that is preferably equal to approximately 1.5 to 3 times the boundary (e.g., voltage). In other words, the Zener diodes ZD1 and ZD2 are configured to keep voltages within approximately 1.5 to 3 times the upper or lower boundaries for the HIGH level voltage. More preferably, they are configured to provide capping voltages equal to approximately twice the upper or lower boundaries for the HIGH level voltage. Approximately 1.5 to 3 times the boundaries are chosen for the Zener diodes ZD1 and ZD2 to ensure that the communication signals are not contaminated with the reflection signals or in consideration of the withstand voltages of the drive elements.

A capacitor C1 is a bypass capacitor used to provide reduced high-frequency impedance between the positive supply 7 side and the negative supply 8 side and between the positive supply 7 side and the negative communication signal 6 side. And it acts to pass electrical current of reflection signals flowing out via the positive communication signal 5 side, from the negative communication signal 6 side to the positive communication signal 5 side through the negative supply 8 side, the capacitor C1, and the positive supply 7 side.

FIG. 2 depicts a receiver circuit 20 configured to receive positive communication signals 5 and negative communication signals 6 transmitted by the transmitter circuit 2. A Zener diode ZD3 determines a binarization voltage threshold Vt. Resistors R1 and R2 determine a base current that flows to a transistor Q3. An emitter of the transistor Q3 is connected to a negative supply 23, and a resistor R3 coupled to a positive supply 22 is connected to a collector of the transistor Q3 to generate a voltage thereacross with a collector current to provide a received signal 21.

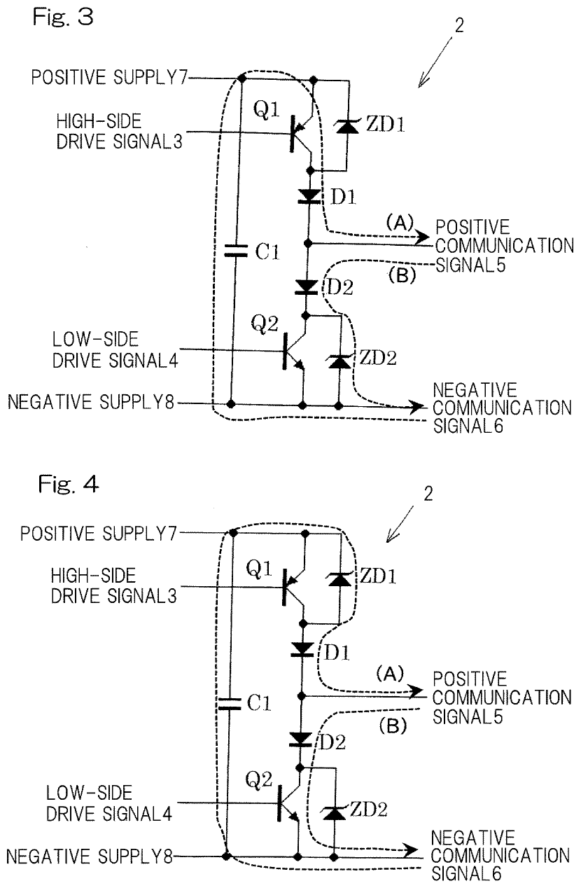

FIG. 3 illustrates how electrical current of reflection signals flows during high-side driving periods (when the communication signals have a HIGH level), and FIG. 4 illustrates how electrical current of reflection signals flows during low-side driving periods (when the communication signals have a LOW level). During high-side driving periods, negative electrical current of reflection signals flows through the transmitter circuit 2 of FIG. 3 along the route (A). That is, the negative electrical current flows from the negative communication signal 6 side to the positive communication signal 5 side through the capacitor C1, the transistor Q1, and the rectifier diode D1. As the reflection time t elapses, the reflection signals flip on the receiver side, so that positive electrical current of the reflection signals flows in FIG. 3 along the route (B). That is, the positive electrical current passes from the positive communication signal 5 side to the negative communication signal 6 side through the rectifier diode D2 and the Zener diode ZD2.

During low-side driving periods, positive electrical current of reflection signals flows through the transmitter circuit 2 of FIG. 4 along the route (B). That is, the positive electrical current flows from the positive communication signal 5 side to the negative communication signal 6 side through the rectifier diode D2 and the transistor Q2. As the reflection time t elapses, the reflection signals flip on the receiver side, so that negative electrical current of the reflection signals flows in FIG. 4 along the route (A). That is, the negative electrical current passes from the negative communication signal 6 side to the positive communication signal 5 side through the capacitor C1, the Zener diode ZD1, and the rectifier diode D1.

According to the present invention, the reflection signal attenuator circuit 10 of the push-pull transmitter circuit 2 in FIG. 1 prevents reflection signals from jeopardizing the amplitude of the communication signals with a simple circuit configuration that uses rectifier diodes D1 and D2 connected in series to high-side and low-side drive elements Q1 and Q2, respectively, as rectifier elements and with a simple circuit configuration that has Zener diodes ZD1 and ZD2 connected in parallel to the high-side and low-side drive elements Q1 and Q2, respectively, to add and subtract voltages and that breakdown voltages (capping voltages) of them are set to approximately 1.5 to 3 times the transmission amplitude At of the communication signals.

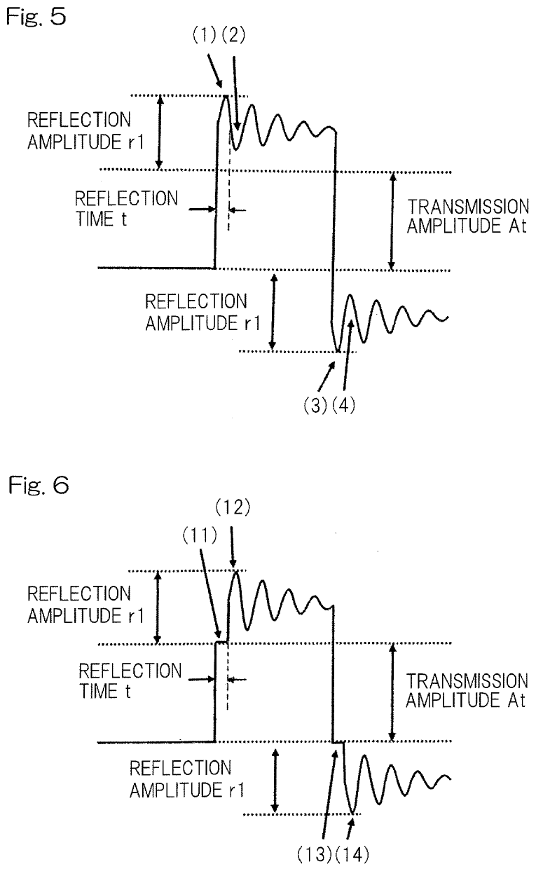

FIG. 5 depicts a waveform on the receiver side according to the transmitter circuit 2 of FIG. 3. The points (1) and (3) in FIG. 5 have a reflection amplitude Γ₁ determined according to equation (1) (where n=1) and a reflection time t determined according to equation (2). FIG. 6 depicts a waveform on the transmitter side according to the transmitter circuit 2 of FIG. 3. Negative electrical current of the reflection signals flows at the point (11) in FIG. 6 during a high-side driving period via the route (A) in FIG. 3, generating a voltage that is equal to the positive supply 7 plus the forward voltage of the diode D1. At the point (12), the reflection signals from the receiver side arrives after the reflection time t according to equation (2), and positive electrical current of it flows via the route (B) in FIG. 3, adding a reflection amplitude Γ₂ (where n=2) according to equation (1) to the transmission amplitude At of the voltage of a positive communication signal with the maximum of it being capped by the breakdown voltage of the Zener diode ZD2.

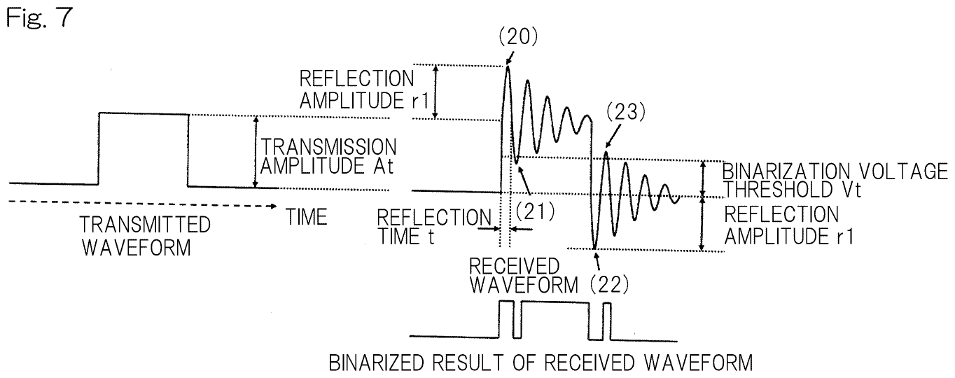

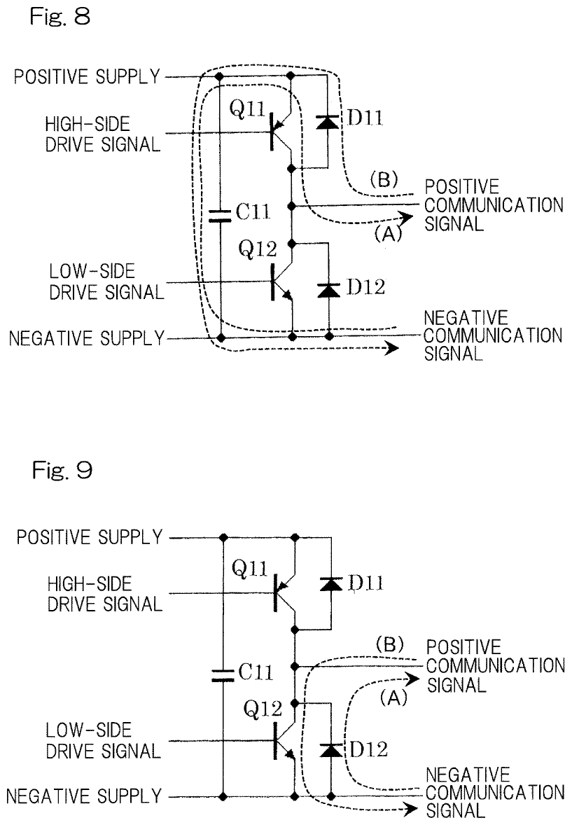

Then, at the point (2) in FIG. 5, the voltage of the reflection signals drops while at the same time the positive electrical current of the reflection signals at the point (12) in FIG. 6 flows via the route (B) in FIG. 3. Hence, the drop at the point (2) is counteracted to some degree at the point (12). In combination with the fact that the reflection signals are biased outwards of the amplitude direction of the communication signals, this ensures that the reflection signals do not dip below the binarization voltage threshold Vt and prevents reflection signals from crossing the binarization voltage threshold Vt unlike the point (21) in FIG. 7 which illustrating a conventional example. Accordingly, the reflection signals can be kept from contaminating the communication signals.

Positive electrical current of the reflection signals flows at the point (13) in FIG. 6 during a low-side driving period via the route (B) in FIG. 4, generating a voltage that is equal to the negative supply 8 minus the forward voltage of the diode D2. At the point (14), the reflection signals from the receiver side arrives after the reflection time t according to equation (2), and negative electrical current of it flows via the route (A) in FIG. 4, resulting in the voltage of the positive communication signal 5 corresponding to the potential difference between the positive supply 7 and the negative supply 8 minus the breakdown voltage of the Zener diode ZD1.

Then, at the point (4) in FIG. 5, the voltage of the reflection signals rises while at the same time the negative electrical current of the reflection signals at the point (14) in FIG. 6 flows via the route (A) in FIG. 3. Hence, the rise at the point (4) is counteracted to some degree at the point (14). In combination with the fact that the reflection signals are biased outwards of the amplitude direction of the communication signals, this ensures that the reflection signals do not rise above the binarization voltage threshold Vt and prevents reflection signals from crossing the binarization voltage threshold Vt unlike the point (23) in FIG. 7 which illustrating a conventional example. Accordingly, the reflection signals can be kept from contaminating communication signals.

Thus, according to the present invention, the reflection signal attenuator circuit 10 of the push-pull transmitter circuit 2 includes rectifier diodes D1 and D2 connected in series to the high-side drive element Q1 and the low-side drive element Q2, respectively, as well as Zener diodes ZD1 and ZD2 connected in parallel to the high-side drive element Q1 and the low-side drive element Q2, respectively, to add or subtract breakdown voltages (to provide capping voltages) equal to approximately 1.5 to 3 times upper or lower boundaries for a HIGH level voltage. This will bias the reflection signals outwards of the amplitude direction of the communication signals to prevent the amplitude of the communication signals from being jeopardized by the reflection signals, thereby keeping the reflection signals from crossing the binarization voltage threshold Vt and from contaminating the communication signals. In this way, attenuation of reflection signals can be easily achieved with a simple circuit configuration with no need for circuit changes when a different electrical line length is used.

It should be noted that while Zener diodes are used as the first and second voltage cap elements in the preceding embodiment, examples of the first and second voltage cap elements are not limited thereto but can also include TVSs (or transient voltage suppressors) and varistors.

While preferred features for carrying out the present invention thus have been discussed on the basis of embodiments with reference to the drawings, the embodiments disclosed herein should be considered illustrative and not restrictive in all respects. The scope of the present invention is to be defined not by the foregoing description but by the claims. A person skilled in the art would readily conceive of a variety of changes and modifications within the scope of obviousness in light of the disclosure herein. Accordingly, such changes and modifications are considered to come within the scope of the invention delimited by the claims or breadth of equivalency thereof.

### REFERENCE SYMBOLS

1 . . . communication system
2 . . . transmitter circuit
3 . . . high-side drive signal
4 . . . low-side drive signal
5 . . . positive communication signal
6 . . . negative communication signal
7 . . . positive supply
8 . . . negative supply
10 . . . reflection signal attenuator circuit
20 . . . receiver circuit
D1, D2 . . . first and second rectifier elements (rectifier diodes)
Q1, Q2 . . . high-side drive element, low-side drive element (drive transistors)
Vt . . . binarization voltage threshold
ZD1, ZD2 . . . first and second voltage cap elements (Zener diodes)
ZD3 . . . Zener diode

What is claimed is:

1. A communication system comprising:
a push-pull transmitter circuit including a high-side drive element and a low-side drive element to transmit communication signals having HIGH and LOW level binary values, the transmitter circuit also including a reflection signal attenuator circuit configured to attenuate an effect that reflection signals appearing on a transmission line of the communication system has on the communication signals by biasing the reflection signals outwards of an amplitude direction of the communication signals to prevent contamination thereof;
and
a receiver circuit configured to receive and discriminate HIGH and LOW levels of the communication signals with a binarization voltage threshold,
the reflection signal attenuator circuit including:
first and second rectifier elements connected in series to the high-side drive element and the low-side drive element, respectively, and configured to prevent the reflection signals from flowing back to a power supply side from the communication signals; and
first and second voltage cap elements connected in parallel to the high-side drive element and the low-side drive element, respectively, and configured to add or subtract capping voltages, equal to approximately 1.5 to 3 times upper or lower boundaries for a HIGH level voltage of the communication signals, to or from the boundaries when passing the reflection signals from the communication signals therethrough.

2. The communication system as claimed in claim 1, wherein the reflection signal attenuator circuit is configured such that:
the first rectifier element connected in series to the high-side drive element prevents positive electrical current of the reflection signals from flowing back to a positive supply side from the communication signals;
the second voltage cap element connected in parallel to the low-side drive element adds a capping voltage equal to approximately 1.5 to 3 times a positive upper boundary for the HIGH level voltage when passing the positive electrical current from the communication signals therethrough;
the second rectifier element connected in series to an output of the low-side drive element prevents negative electrical current of the reflection signals from flowing back to a negative supply side from the communication signals; and
the first voltage cap element connected in parallel to the high-side drive element subtracts a capping voltage equal to approximately 1.5 to 3 times a negative lower boundary for the HIGH level voltage when passing the negative electrical current of the reflection signals from the communication signals therethrough.

3. The communication system as claimed in claim 1 or 2, wherein the first and second voltage cap elements are configured to add or subtract capping voltages equal to approximately twice the upper or lower boundaries for the HIGH level voltage.
